(19) United States
(12) Patent Application Publication
(10) Pub. No.: US 2021/0284014 A1
(43) Pub. Date: Sep. 16, 2021

(54) FINAL DRIVE FOR A MOTOR VEHICLE

(71) Applicant: AUDI AG, Ingolstadt (DE)

(72) Inventor: Christian MEIXNER, Ingolstadt (DE)

(73) Assignee: AUDI AG, Ingolstadt (DE)

(21) Appl. No.: 16/336,639

(22) PCT Filed: Sep. 19, 2017
(86) PCT No.: PCT/EP2017/073575

§ 371 Date: Mar. 26, 2019

(30) Foreign Application Priority Data
Sep. 28, 2016 (DE) 10 2016 218 722.8

(51) Int. Cl. B60K 17/04; B60K 17/24; F16H 57/038

(52) U.S. Cl. CPC B60K 17/043; B60K 17/24; F16H 2057/02052; F16H 57/038; B60K 17/04

(57) ABSTRACT

A final drive for a motor vehicle, including a first input shaft, a second input shaft, a first output shaft, and a second output shaft, wherein the first input shaft is permanently coupled to the first output shaft by a first bevel-gear transmission and the second input shaft is permanently coupled to the second output shaft by a second bevel-gear transmission. The first input shaft and the second input shaft are arranged coaxial to each other and the first output shaft and the second output shaft extend from the respective bevel-gear in opposite directions.

The invention relates to a final drive for a motor vehicle, comprising a first input shaft, a second input shaft, a first output shaft, and a second output shaft, wherein the first input shaft is permanently coupled to the first output shaft by means of a first bevel-gear transmission and the second input shaft is permanently coupled to the second output shaft by means of a second bevel-gear transmission.

The final drive is associated with an axle of a motor vehicle, for example a front axle, but preferably a rear axle of the motor vehicle. The final drive is used to transmit a torque from a drive mechanism of the motor vehicle to wheels of the motor vehicle. In other words, the final drive is or at least can be used to establish an operative connection between the drive mechanism of the motor vehicle and the axle or its wheels. The drive mechanism is or at least can be permanently coupled to the first input shaft and the second input shaft. For example, the operative connection between the drive mechanism and the two input shafts is provided by means of a transmission unit which is different from the final drive. The transmission unit can for example be configured as a differential gear unit, particularly an axial differential gear unit. The two input shafts can be cardan shafts themselves or at least coupled to cardan shafts, particularly permanently coupled.

For example, the two input shafts of the final drive are permanently, particularly rigidly, coupled to the output shafts of the transmission unit. The two output shafts of the final drive are provided on the wheel sides, that is, in terms of torque flow, they are arranged on a side of the bevel-gear transmissions facing away from the drive mechanism. The first output shaft is for example associated with a first wheel of the axle and the second output shaft is associated at least with a second wheel of the same axle, particularly permanently and/or rigidly coupled to said wheel. The operative connection between the first output shaft and the first wheel and/or the operative connection between the second output shaft and the second wheel may, of course, be at least temporarily interruptible. For this purpose, a shifting clutch, e.g. a dog clutch, can be provided in each of the operative connections.

In the final drive, the first input shaft is permanently coupled to the first output shaft and the second input shaft is permanently coupled to the second output shaft. For this purpose, the first bevel-gear transmission and the second bevel-gear transmission are used. An angled arrangement of the input shafts and the output shafts to each other is achieved by means of the bevel-gear transmissions. For example, the bevel-gear transmissions may comprise a hypoid-type offset, such that the output shafts are offset, particularly obliquely, with respect to the input shafts, that is, are parallel to them at a spacing. But this requires a rather large installation space for the final drive.

It is the problem of the invention to propose a final drive for a motor vehicle which has advantages compared to known final drives, particularly has a smaller installation space requirement.

This problem is solved, according to the invention, by a final drive having the features of claim 1. According to the invention, the first input shaft and the second input shaft are arranged coaxial to each other and the first output shaft and the second output shaft extend from the respective bevel-gear transmissions in opposite directions, wherein an axis plane contains the axes of rotation of the input shafts and a plane perpendicular to the axis plane includes an angle of at least 75° and at most 90° with each of the axes of rotation of the output shafts, and the first bevel-gear transmission and the second bevel-gear transmission are arranged in a drive housing, which has a first housing shell and a second housing shell, which are formed separate from each other and contact each other in a contact plane, which lies in the axis plane or parallel thereto.

All in all, a special arrangement of the input shafts and the output shafts is provided. This again allows a special design of the drive housing, that is, a multi-part design. The two input shafts are arranged coaxial to each other. For example, the second input shaft extends in the first input shaft, or vice versa. The two output shafts are substantially opposite, particularly with respect to the symmetry plane, and extend in opposite directions from the respective bevel-gear transmission, preferably in the direction of the respective wheel of the motor vehicle.

Both the axis of rotation of the first output shaft and the axis of rotation of the second output shaft intersect the two axes of rotation of the input shafts or the joint axis of rotation of the input shafts. In other words, the axes of rotation of the output shafts intersect the axes of rotation of the input shafts. Accordingly, the bevel-gear transmissions can be configured without a hypoid offset. But a configuration with a hypoid offset can also be implemented, in which however the axis of rotation of at least one of the output shafts does not intersect the axes of rotation of the input shafts. It is preferred that in this case, the axes of rotation of both output shafts do not intersect the axes of rotation of the input shafts. Thus the axes of rotation of the output shafts are arranged obliquely with respect to the axes of rotation of the input shafts.

In addition, the (imagined) axis plane contains the axes of rotation of the input shafts. The axis plane is arranged substantially horizontally with respect to an installation position of the final drive. Accordingly, the plane arranged perpendicular to the axis plane, which plane also contains the axes of rotation of the input shafts, is present as a vertical plane and is thus arranged substantially perpendicular to the installation position of the final drive. The plane perpendicular to the axis plane encloses at least in section, particularly in cross section, an angle of at least 75° and at most 90° with the axes of rotation of the output shafts.

Each of the axes of rotation thus encloses an angle which meets the conditions mentioned above. The angles between the axes of rotation and the plane can be identical, alternatively different from each other. For example, the angle(s) is/are at least 75° and at most 90°. It is preferred that the angle(s) is/are at least 80°, at least 85°, at least 86°, at least 87°, at least 88°, or at least 89°, but always at most 90°. This means that the angle(s) can be precisely 90° or smaller than 90°.

In addition, or alternatively, the plane perpendicular to the axis plane is at least in section, particularly viewed in cross section with respect to the axes of rotation of the input shafts, a symmetry plane for the axes of rotation of the output shafts. The axes of rotation of the output shafts are in this case arranged or oriented symmetrical to each other with respect to the symmetry plane.

For a particularly compact design of the final drive, the drive housing in which the bevel-gear transmissions are arranged has a multi-part configuration and comprises a first housing shell and a second housing shell. The arrangement or orientation of the input shafts and output shafts described above allows a division of the drive housing into the first housing shell and the second housing shell in a substantially horizontal plane with respect to the installation position of the final drive, which plane will hereinafter be called the contact plane. Said contact plane is in the axis plane or parallel thereto. In the context of this specification, the main reference is not to the horizontal orientation of the contact plane but to its position with respect to the axis plane to obtain an integrated definition for the final drive.

The first housing shell and the second housing shell are adjacent in the contact plane or abutting in the contact plane. A first contact surface of the first housing shell preferably contacts a second contact surface of the second housing shell. The first contact surface and the second contact surface are preferably flat or planar, respectively. It is particularly preferred that the first contact surface and the second contact surface are each situated in regions on opposite sides of the symmetry plane. The contact surfaces are preferably completely located in the contact plane but are at least intersected by it.

In another embodiment of the invention, the axes of rotation of the two input shafts and the axes of rotation of the two output shafts are in the same axis plane. This represents a particularly advantageous orientation of the input shafts and output shafts, which allows an extremely compact configuration of the final drive. If both the input shafts and the output shafts are arranged in the axis plane, the above definition using the symmetry plane can be omitted. It is no longer necessary for defining the axis plane.

In a particularly preferred embodiment of the invention, the first housing shell and the second housing shell are screwed to each other by means of a screw, wherein a central longitudinal axis of the screw is at an angle to the contact plane, particularly, is perpendicular to it. The screw engages both in the first housing shell and in the second housing shell. For example, a head of the screw rests against a first of the housing shells, that is, on the side facing away from the housing shell. A thread of the screw which is at a spacing from the head engages in the other of the housing shells, such that these are reliably held together. Particularly preferred is of course a multitude of such screws, which are located at a spacing from each other on the housing shell.

The central longitudinal axis of the screw is at an angle to the contact plane. It is particularly preferably perpendicular to the contact plane. Such a configuration allows a particularly compact final drive because no fastening flanges which project upwards and downwards are necessary to fasten the two housing shells to each other. Instead, the fastening flanges can be located laterally on the drive housing, particularly in the contact plane or parallel thereto. Accordingly, the screw can also be in the contact plane or pass through it. It is preferred that not only the central longitudinal axis is perpendicular to the contact plane. Instead, the contact plane extends through the screw.

In a further development of the invention, the first housing shell comprises a planar first contact surface located in the contact plane and the second housing shell comprises a second contact surface located in the contact plane, wherein the first contact surface and the second contact surface rest flatly against each other. The housing shells are arranged so as to rest against each other. The two contact surfaces of the housing shells get into direct contact with each other. Both the first contact surface and the second contact surface are planar. It is preferred that they lie completely in the contact plane. For example, the first contact surface rests against the second contact surface and/or vice versa. Particularly, the entire first contact surface rests against the entire second contact surface, establishing area-filled contact between the contact surfaces.

Alternatively, the first contact surface and the second contact surface may each be planar and lie in an imagined plane. Both of these imagined planes are now to be at an angle to the contact plane, that is, enclose an angle with it that is greater than 0° and smaller than 90°. The angle is preferably considerably smaller than 90°, for example it is at most 80°, at most 70°, at most 60°, at most 50°, at most 45°, at most 40°, or at most 30°.

Another preferred embodiment of the invention, the screw passes through the first contact surface and/or the second contact surface. The two contact surfaces are held together or forced against each other by the screw after assembly of the drive housing. The screw, however, is not arranged at a spacing from the contact surfaces, for example on a separate fastening flange. Instead, the screw is arranged in a screw hole which passes through the first contact surface and the second contract surface, but preferably closed on the rim.

In another embodiment of the invention, the first contact surface extends in the direction of the axes of rotation of the input shafts from one end of the first housing shell to its other end, and/or the second contact surface extends in the direction of the axes of rotation of the input shafts from one end of the second housing shell to its other end. The first contact surface thus extends between the two ends of the first housing shell and up to each of its ends. But this does not mean that the first contact surface must be continuous between the two ends, even though this is preferably the case.

In this respect, the first contact surface can extend from the one end to the other end in a first variant. In a second variant, the first contact surface is formed by several partial surfaces, wherein one of the partial surfaces extends up to the one end and the other of the partial surfaces extends up to the other end of the first housing shell. The two partial surfaces can have a spacing between each other in the axial direction. In addition, or alternatively, this applies analogously to the second contact surface, which is located on the second housing shell. The designs for the first contact surface on the first contact shell can easily be transferred to the second contact surface on the second housing shell.

In another embodiment of the invention, the first contact surface and/or the second contact surface can each be located partially on a first side and partially on a side opposite said first side in a median plane which contains one of the axes of rotation of the input shafts and is arranged perpendicular to the contact plane. The two contact surfaces may thus each consist of partial surfaces. It has been pointed out above that there may be a division in the axial direction with respect to the axes of rotation of the input shafts. In addition, or alternatively, the contact surfaces may also be divided into partial surfaces which are arranged on opposite sides of the median plane.

The median plane may in principle correspond to the symmetry playing described above. Like said plane, it contains the axes of rotation of the input shafts and is perpendicular to the contact plane. The first contact surface and the second contact surface are preferably continuous in the axial direction, but have each opposing partial surfaces with respect to the median plane. Both the first contact surface and the second contact surface each comprise at least two partial surfaces, which are arranged on opposite sides of the median plane. It is particularly preferred that each of the partial planes extends in the axial direction from the one end of the respective housing shell to the opposite end of the housing shell, that is, across its entire extension in the axial direction.

In a preferred embodiment of the invention, the first input shaft and the second input shaft as well as the first output shaft and the second output shaft are mounted on and/or in the drive housing. Bearings are provided for mounting the input shafts or output shafts, respectively, which bearings are preferably fixed with respect to the drive housing. Each shaft is for example associated with at least one of these bearings. Alternatively, both the first output shaft and the second output shaft can each be mounted by means of a first bearing and the second bearing.

The two bearings may in principle be arranged in any position relative to each other, particularly they are arranged at a spacing in the axial direction with respect to the respective axis of rotation of the respective output shaft. The first bearing and the second bearing may for example be arranged in an O-arrangement, in a tandem arrangement, or in an X-arrangement. Alternatively, the first bearing at the second bearing may be provided as a fixed bearing and as a floating bearing. The input charts and the output shafts, at least sections thereof, are each preferably located in the drive housing. The bevel-gear transmissions, particularly the bevel gears of the bevel-gear transmissions, are preferably completely housed in the drive housing.

In another embodiment of the invention, the first input shaft and the second input shaft may be mounted on opposite sides of the bevel-gear transmissions on or in the drive housing. The sides on which the input shafts are mounted are opposite in an axial direction with respect to the bevel-gear transmissions. In other words, the first input shaft and the second input shaft are mounted on opposite sides of the points of intersection of the axes of rotation of the output shafts with the input shafts on or in the drive housing, respectively. The first input shaft is mounted on a first side and the second input shaft is mounted on a side opposite said first side. The first input shaft is preferably only mounted on the first side, while the second input shaft may be mounted both on the first side and on the second side.

In yet another embodiment of the invention, the first output shaft passes through a first outlet opening of the drive housing and the second output shaft passes through a second outlet opening of the drive housing. The two outlet openings are located on opposite sides of the drive housing. The first output shaft thus extends starting from, or passes through, the first bevel-gear transmission towards the first outlet opening, while the second output shaft extends from, or passes through, the second bevel-gear transmission towards the second outlet opening. This means that the two output shafts project from the drive housing through the outlet openings.

In a preferred embodiment, the first outlet opening and the second outlet opening can each be formed in sections, particularly in equal parts, in the first housing shell and in the second housing shell. Each of the outlet openings thus engages in each of the housing shells, at least partially. It is particularly preferred that equal parts of the outlet openings are formed in the housing shells. This allows a particularly simple assembly of the final drive.

The invention will be explained in more detail below based on the exemplary embodiments shown in the drawing, but without limiting the invention in any way. Wherein:

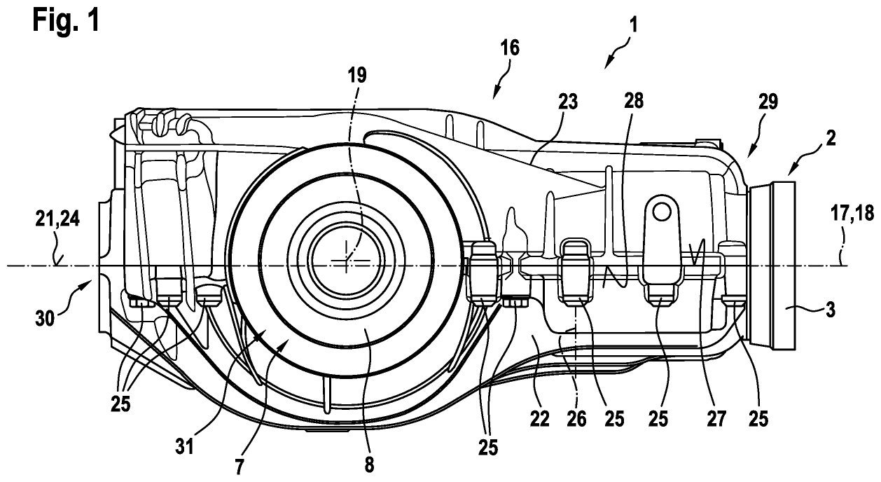

FIG. 1 shows a schematic side view of a final drive for a motor vehicle,

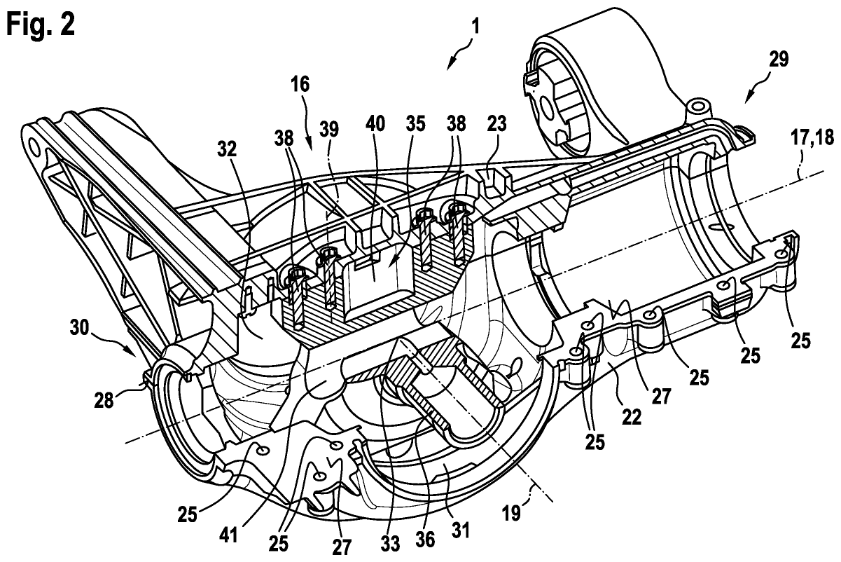

FIG. 2 shows a schematic cross sectional view through a drive housing and a bearing member arranged in the drive housing,

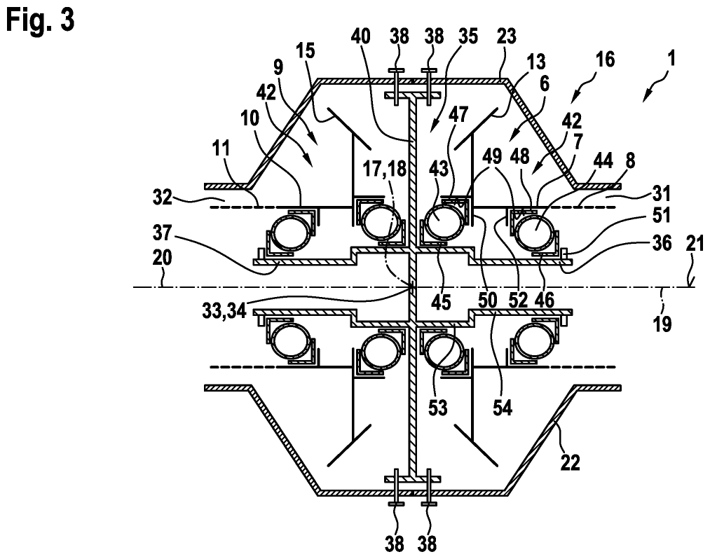

FIG. 3 shows a schematic view of first embodiment of the final drive,

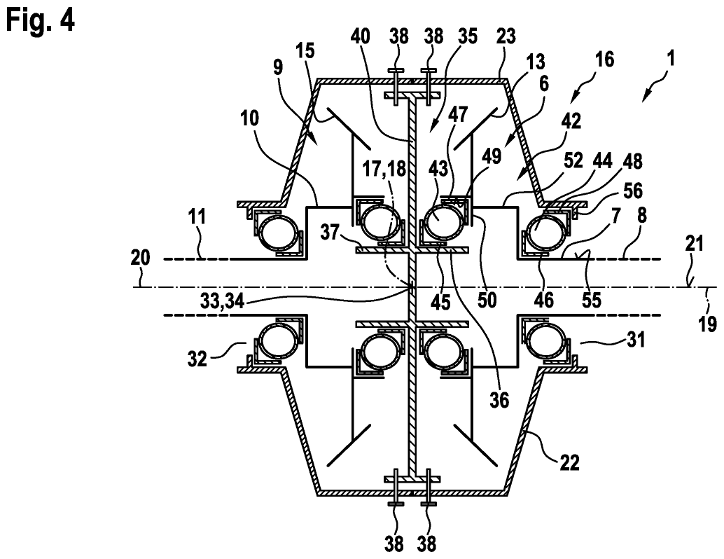

FIG. 4 shows a schematic view of second embodiment of the final drive,

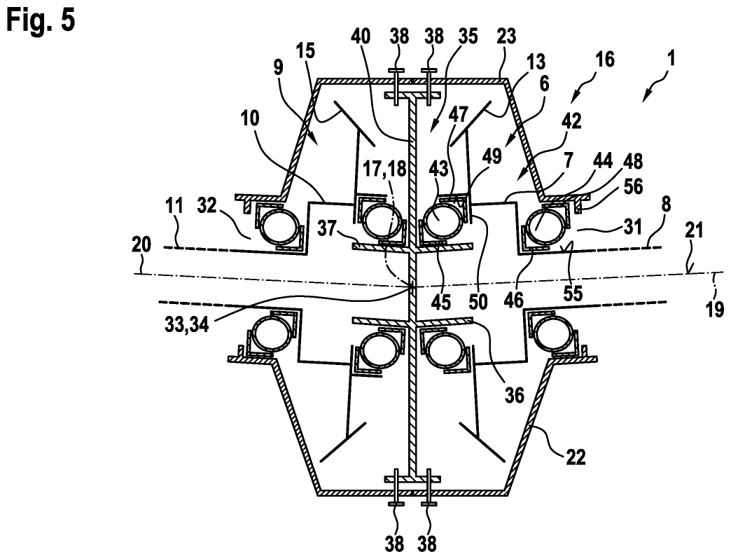

FIG. 5 shows a schematic view of a first variant of a third embodiment of the final drive, and

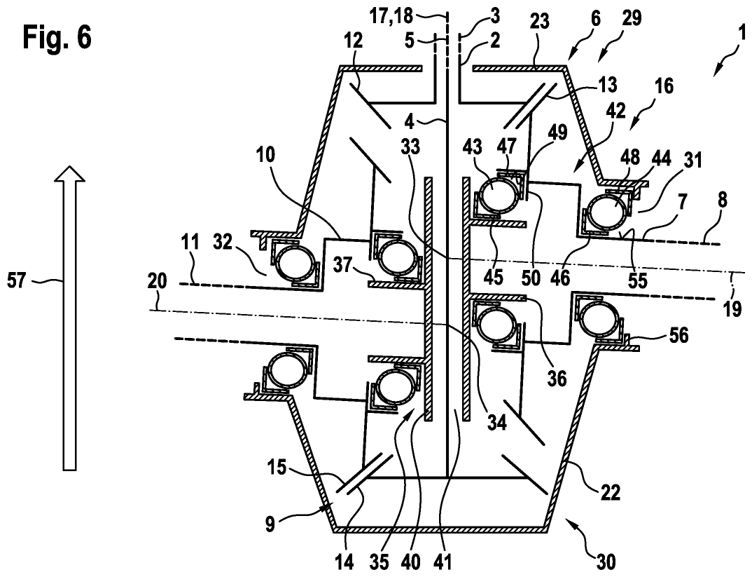

FIG. 6 shows a schematic view of second variant of the third embodiment of the final drive.

FIG. 1 shows a schematic side view of a final drive 1 for a motor vehicle. The final drive has a first input shaft 2, of which a connecting flange 3 is shown here. A second input shaft 4 not visible here is arranged coaxial with the first input shaft 2. The first input shaft 2 is configured as a hollow shaft and the second input shaft 4 is arranged and/or mounted inside the first input shaft 2. The second input shaft 4 comprises a connecting flange 5, which is preferably arranged in the connecting flange 3 of the first input shaft 2. The first input shaft 2 is permanently coupled to a first output shaft 7 by means of a first bevel-gear transmission 6. The first output shaft 7 has a connecting flange 8, which is visible here. Likewise, the second input shaft 4 is permanently coupled by means of a second bevel-gear transmission 9 to a second output shaft 10 not visible here, which comprises a connecting flange 11.

The first bevel-gear transmission 6 consists of a bevel gear 12, which is rigidly and permanently coupled to the first input shaft 2, and a bevel gear 13, which is in meshed engagement with the bevel gear 12 and is rigidly and permanently coupled to the first output shaft 7. Likewise, the second bevel-gear transmission 9 comprises a bevel gear 14, which is rigidly and permanently coupled to the second input shaft 4, and a bevel gear 15, which is in meshed engagement with the bevel gear 14 and is rigidly and permanently coupled to the second output shaft 10. The bevel-gear transmissions 6 and 9 and accordingly the bevel gears 12, 13, 14, and 15 are arranged in a drive housing 16 of the final drive 1, particularly completely. In other words, the drive housing 16 preferably fully encloses the bevel-gear transmissions 6 and 9.

It has been pointed out that the first input shaft 2 and the second input shaft 4 are arranged coaxially to each other, wherein the second input shaft 4 is arranged inside the first input shaft 2. The input shafts 2 and 4 thus comprise coinciding axes of rotation 17 and 18. The first output shaft 7 and the second output shaft 10 extend in opposite directions, starting from the bevel-gear transmission 6 or 9, respectively. In the exemplary embodiment shown, the first output shaft 7 thus extends outside of the drawing plane, while the second output shaft 10 extends into the drawing plane. An axis of rotation 19 of the first output shaft 7 or of each connecting flange 8 is arranged slightly askew in the vertical direction and intersects the axes of rotation 17 and 18. This applies accordingly to an axis of rotation 20, not visible here, of the second output shaft 10 or its connecting flange 11.

The input shafts 2 and 4 or their axes of rotation 17 and 18, respectively, lie in an axis plane 21, which is generally arranged horizontally. In other words, an imagined plane, which, viewed in section, particularly in cross section with respect to the axes of rotation 17 and 18, is a symmetry plane for the axes of rotation 19 and 20 of the output shafts 7 and 10, is perpendicular to the axis plane 21. The axes of rotation 19 and 20 are symmetrically arranged and oriented to this imagined plane, which can also be called a vertical plane due to the horizontal arrangement of the axis plane 21.

Since the imagined plane serves as a symmetry plane for the axes of rotation 19 and 20, the axes of rotation 19 and 20 intersect both the symmetry plane and the axis plane at the same angle. In other words, the axis of rotation 19 is at a first angle with respect to the axis plane 21 and the symmetry plane, respectively, and the axis of rotation 20 is at a second angle with respect to the axis plane 21 and the symmetry plane, respectively, wherein the two angles are equal. This means that in general the axes of rotation 19 and 20 intersect the axis plane 21. Alternatively, the axes of rotation 19 and 20 may completely lie in the axis plane 21.

To allow a space-saving configuration of the final drive 1, the drive housing 16 is configured in multiple parts and comprises a first housing shell 22 and a second housing shell 23, which are formed separate from each other and rest against each other in a contact plane 24, which lies in the axis plane 21 or is parallel thereto. The first housing shell 22 and the second housing shell 23 are screwed to each other by means of a screw 25, in the exemplary embodiment shown by means of a multitude of screws 25. At least one of the screws 25, preferably all the screws 25, comprise a central longitudinal axis 26, which is at an angle to the contact plane 24, that is, intersects it at a specific angle.

It is therefore not envisaged that the screw 25 or its central longitudinal axis 26 are arranged parallel to the contact plane 24 or that the central longitudinal axis 26 lies in the contact plane 24. Instead, the central longitudinal axis 26 is preferably perpendicular to the contact plane 24. In addition, the contact plane 24 passes through at least one of the screws 25, i.e. is intersected by the contact plane 24.

This means for the arrangement of the screw 25 that it is located laterally on the drive housing 16 and not on a separate fastening flange, which would be provided on a top side or a bottom side of the drive housing 16 for fastening shells 22 and 23 to each other. Such a fastening flange simply is not provided in the advantageous embodiment of the final drive 1 described herein. Such a configuration allows for a considerable reduction of the installation space required in the vertical direction, that is, in the symmetry plane, compared to other final drives 1.

The first housing shell 22 comprises a planar first contact surface 27 which lies in the contact plane 24, and the second housing shell 23 comprises a planar second contact surface 28, which lies in the contact plane 24. The two contact surfaces 27 and 28 rest against each other over a large area, preferably across their entire area, after the assembly of the housing shells 22 and 23. Contact across the entire area means that the entire first contact surface 27 rests against the entire second contact surface 28. Each of the contact surfaces 27 and 28 thus completely covers the respective other contact surface 28 or 27.

The screw 25 passes through both the first contact surface 27 and the second contact surface 28. The screw engages both in the first housing shell 22 and in the second housing shell 23 for their fastening. In the exemplary embodiment shown herein, the first contact surface 27 extends in the direction of the axes of rotation 17 and 18 from one end 29 of the drive housing 16 to its other end 30. In addition, or alternatively, this applies to the second contact surface 28. Particularly, both the first contact surface 27 and the second contact surface 28 extend on the one hand up to the end 29 and on the other hand up to the end 30.

However, the contact surfaces 27 and 28 may be interrupted between the ends 29 and 30. In the exemplary embodiment shown, this is the case for both contact surfaces due to a first outlet opening 31 for the first output shaft 7 or its connecting flange 8 and for the second outlet opening 32 for the second output shaft 10 or its connecting flange 11. The first output shaft 7 passes through the first outlet opening 31 or is arranged therein, while the second output shaft 10 passes through the second outlet opening 32 or is arranged therein.

It is particularly preferred that the outlet openings 31 and 32 are each formed in equal parts in the housing shell 22 and in the second housing shell 23. At least, however, each of the outlet openings 31 and 32 is at least partially located in the first housing shell 22 and at least partially located in the second housing shell 23. The contact surfaces 27 and 28 thus comprise two partial surfaces, which are located on opposite sides of the outlet openings 31 and 32 when viewed in the axial direction with respect to the axes of rotation 17 and 18.

FIG. 2 shows a schematic partial cross-sectional view of a part of the final drive 1. The input shafts 2 and 4 and the output shafts 7 and 10 are not shown. This is also true for the bevel-gear transmissions 6 and 9. In general however, reference is made to the explanations above. It is now clearly visible that the axis of rotation 19 and the axes of rotation 17 and 18 intersect at a point of intersection 33. This applies likewise to the axis of rotation 20 at a point of intersection 34, which is not shown here but may coincide with the point of intersection 33.

It is further visible now that a bearing member 35 is arranged in the drive housing 16 in a preferred embodiment of the final drive 1. It comprises a first bearing protrusion 36 and an opposing second bearing protrusion 37, which is not visible here. The first bevel gear 13, which is rigidly connected to the first output shaft 7, is pivotably mounted on the first bearing protrusion 36, and the bevel gear 15 of the second bevel-gear transmission 9, which gear is rigidly connected to the second output shaft 10, is pivotably mounted on the second bearing protrusion 37 . The first bearing protrusion 36 protrudes in the direction of the first outlet opening 31, particularly protrudes into the same or even passes through it towards the axis of rotation 19. Vice versa, the second bearing protrusion 37 protrudes in the direction of the second outlet opening 32. It can protrude into the same or even pass through it towards the axis of rotation 20.

The bearing member 35 is fastened to the first housing shell 22 on the one hand and to the second housing shell 23 on the other. Fastening is achieved by means of at least one screw 38, preferably by means of multiple screws 38. This is only visible here for the fastening of the bearing member 35 to the second housing shell 23. But it is preferred that the respective explanations can be transferred to the fastening of the bearing member 35 to the first housing shell 22. It can be seen that the screw(s) 38 each comprise a central longitudinal axis 39. The screw 38 or its central longitudinal axis 39 are at an angle to the contact plane 24 (not shown here). Particularly, it is perpendicular to the contact plane 24. This means that the central longitudinal axis 39 of the screw 38 is preferably parallel to the central longitudinal axis 26 of the screw 25.

The screw 38 engages in a central spike 40 of the bearing member 35 for securing the bearing member 35 to the drive housing 16. On the opposite side, the bearing protrusions 36 and 37 protrude from the central spike 40. Furthermore, a through recess 41 for receiving the second input shaft 4 can be configured in the central spike 40, particularly between the bearing protrusions 36 and 37. The second input shaft 4 preferably passes completely through the bearing member 35, particularly through the through recess 41 in the axial direction of the axes of rotation 17 and 18.

The bevel-gear transmissions 6 and 9 are preferably configured such that the bevel gears 12 and 14, which are connected to the input shafts 2 and 4, are located on opposite sides of the bearing member 35, that is, on opposite sides of a plane which is perpendicular to the axes of rotation 17 and 18. Particularly, the bevel gear 12 is completely located on one side of this plane and the bevel gear 14 is completely located on the opposite side of the plane. The bearing member 35 is preferably made of one piece and/or a uniform material. For example, it can be made of the same material as the housing shells 22 and 23. The use of the bearing member 35 allows a particularly compact configuration of the final drive 1, particularly in the vertical direction.

FIG. 3 shows a schematic cross-sectional view of the final drive 1, that is, a cross section with respect to the axes of rotation 17 and 19, wherein the section plane is perpendicular to the axes of rotation 17 and 18 and preferably contains the axes of rotation 19 and 20. The viewing direction in the cross section is towards the end 29. The input shafts 2 and 4 are not shown. It can be seen that each of the bevel gears 13 and 15 or each of the output shafts 7 and 10, respectively, are mounted in the drive housing 16 by means of a bearing arrangement 42. The bearing arrangements 42 for the bevel gears 13 and 15 or the output shafts 7 and 10, respectively, are similar, but not mirror-symmetrical. The bearing arrangement 42 for the bevel gear 13 or the first output shaft 7, respectively, will be explained in detail below. These explanations can always be transferred to the bearing arrangement 42 for the bevel gear 15 or the first output shaft 10, respectively.

The bearing arrangement 42 comprises a first radial bearing 43 and a second radial bearing 44. These are arranged in an 0 pattern to each other. Alternatively, they can be configured as a fixed bearing or a floating bearing. In the latter case, one of the radial bearings 43 and 44 forms the fixed bearing and the respective other of the radial bearings 43 and 44 forms the floating bearing. Below, the O-arrangement shown here will be explained in detail. The explanations apply likewise to the configuration of the radial bearings 43 and 44 as fixed bearing and floating bearing. The radial bearings 43 and 44 are preferably configured as roller bearings, particularly as ball bearings.

The radial bearings 43 and 44 are both arranged on the first bearing protrusion 36. This means that their inner rings 45 and 46 are seated on the first bearing protrusion 36. Outer rings 47 and 48 of the radial bearings 43 and 44, on the other hand, are arranged on the bevel gear 13 and/or the first output shaft 7. Accordingly, the outer rings 47 and 48 rest against an inner bearing surface 49 of the bevel gear 13 or the output shaft 7, respectively. The first radial bearing 43 is supported in the axial direction with respect to the axis of rotation 19 on the central spike 40 of the bearing member 35. In other words, the first radial bearing 43 is arranged in the axial direction with respect to the axis of rotation 19 between the central spike 40 and the bevel gear 13 or an axial bearing protrusion 50 of the bevel gear 13, respectively. Particularly, the radial bearing 43 permanently rests against the central spike 40 and permanently rests against the axial bearing protrusion 50.

The second radial bearing 44 is preferably secured by a fastening means 51 in the axial direction outwards, that is, in the direction away from the central spike 40. A snap ring or the like may for example be used as fastening means 51. Particularly, the fastening means 51 can be detached again. The radial bearing 44 is preferably arranged between the fastening means 51 and the bevel gear 13, or an axial bearing protrusion 52 of the bevel gear 13 or the first output shaft 7, respectively. Particularly, the second radial bearing 44 permanently rests against the central spike 51 on the one hand, and permanently rests against the axial bearing protrusion 52 on the other.

The axial bearing protrusions 50 and 52 may be different from each other and arranged at a spacing from each other, particularly in the axial direction. The axial bearing protrusions 50 and 52 may also be configured as a joint axial bearing protrusion, wherein the first radial bearing 43 is located on one side and the second radial bearing 44 is located on the axially opposite side of this joint axial bearing protrusion. It becomes evident that the bearing arrangement 42, that is, both the first radial bearing 43 and the second radial bearing 44 are only fastened to the drive housing 16 via the bearing member 35. The radial bearings 43 and 44 thus are only connected to the drive housing 16 via the bearing member 35.

It is further visible that the first bearing protrusion 36 comprises a first region 53 and a second region 54, which differ in diameter. The first bearing protrusion 36 has a first diameter in the first region 53 and a second diameter in the second region 54, wherein the first diameter is greater than the second diameter. The first region 53 is preferably directly adjacent to the central spike 40, at any case it is arranged on the side of the second region 54 which faces the central spike 40. The two regions 53 and 54 are preferably directly adjacent to each other in the axial direction with respect to the axis of rotation 19.

The first radial bearing 43 is now seated in the first region 53 and the second radial bearing 44 is seated in the second region 54 on the first bearing protrusion 36. The inner ring 45 thus has a greater diameter than the inner ring 46. The radial bearings 43 and 44 are preferably of equal size in the radial direction, such that, like the inner rings 45 and 46, the outer ring 47 has a greater diameter than the outer ring 48. It goes without saying that the radial bearings 43 and 44 can be selected such that the diameter difference between the inner rings 45 and 46 is different from the diameter difference of the outer rings 47 and 48. For example, the inner rings 45 and 46 may have different diameters, while the outer rings 47 and 48 have the same diameter.

FIG. 4 shows a second embodiment of the final drive 1, again in a cross-sectional view. In principle, we can refer to the previous explanations and will only address the differences below. These differences are that the radial bearings 43 and 44 of the bearing arrangement 42 are now arranged in a tandem pattern to each other. Alternatively, an X-arrangement of the radial bearings 43 and 44 or once again—as explained above—a configuration of the radial bearings 43 and 44 as fixed bearing and floating bearing would be conceivable. We will explain the tandem arrangement in detail below. The explanations apply likewise to the X-arrangement and the configuration as fixed bearing and floating bearing.

The first radial bearing 43 is arranged like in the first embodiment of the final drive 1. Accordingly, its inner ring 45 is seated on the first bearing protrusion 36. In the axial direction, it is preferably supported on the central spike 40 on the one hand and on the axial bearing protrusion 50 on the other hand. Differences result from the second radial bearing 44. Its inner ring 45 is seated on an outer bearing surface 55 of the bevel gear 13 or the first output shaft 7, respectively. While the first radial bearing 43 engages in the bevel gear 13 or the output shaft 7, the second radial bearing 44 encompasses the bevel gear 13 or the output shaft 7, respectively. As a result, the first bearing protrusion 36 can be shorter and have a uniform diameter. The fastening means 51 can also be eliminated.

The second radial bearing 44 on the one hand is in contact with the bevel gear 13 or the output shaft 7, respectively, on the other hand it is in direct contact with the drive housing 16, particularly with the two housing shells 22 and 23. The axial bearing protrusion 52 is now formed by a bearing shoulder of the bevel gear 13 or the output shaft 7, respectively. This may once again be shown by means of a diameter change.

To secure the second radial bearing 44 at least outwards in the axial direction with respect to the drive housing 16, the drive housing 16 also comprises an axial bearing protrusion 56. It is preferably formed both on the first housing shell 22 and on the second housing shell 23. The second radial bearing 44 is now located between the axial bearing protrusion 52 and the axial bearing protrusion 56 when viewed in the axial direction with respect to the axis of rotation 19. Particularly preferably, it permanently rests against the axial bearing protrusion 52 on the one hand and permanently rests against the bearing protrusion 56 on the other hand.

FIG. 5 shows a first variant of a third embodiment of the final drive 1. It shows once again a schematic cross sectional view in accordance with the explanations above.

The bearing arrangement 42 has a similar configuration as the second embodiment described above. A bearing arrangement 42 according to the first embodiment may also be used. In this respect, reference is made to the explanations above. We will only mention the differences to the first two embodiments below. These differences are based on the fact that the bevel gears 13 and 15 and thus the axes of rotation 19 and 20 do not extend parallel, but at an angle to each other.

This means that the axes of rotation 19 and 20 further intersect the axes of rotation 17 and 18 at the point of intersection 33 and 34, wherein the point of intersection 33 and 34 may coincide. In very general terms, the axes of rotation 19 and 20 each intersect both axes of rotation 17 and 18. The axes of rotation 19 and 20 may also intersect each other or, alternatively, be arranged obliquely to each other, particularly at a parallel spacing from each other. In a first variant shown here, the axes of rotation 19 and 20 intersect. The axes of rotation 19 and 20 are arranged at the same angle to the axis plane 21 or contact plane 24, respectively, such that the plane that is perpendicular to the contact plane 24 and accommodating the axes of rotation 17 and 18 is the symmetry plane for the axes of rotation 19 and 20.

FIG. 6 shows a second variant of the third embodiment. It shows a cross sectional view through the final drive, that is, a longitudinal cross section with respect to the axes of rotation 17 and 18. The section plane is selected such that there is a viewing direction towards the first housing shell 22. Reference is made expressly to the explanations above. Furthermore, it can clearly be seen that the bevel gears 12 and 14 of the bevel-gear transmissions 6 and 9 are arranged on opposite sides of the bearing member 35. For this purpose, the second input shaft 4 passes through the bearing member 35, particularly it passes through the through recess 41, as explained above. A direction of travel of a motor vehicle with which the final drive 1 is associated is indicated by the arrow 57.

In addition, or alternatively, to the first variant described above, in which the axes of rotation 19 and 20 are at an angle with respect to the axis plane, the axes of rotation 19 and 20 may here also be offset from each other in the axial direction with respect to the axes of rotation 17 and 18. For example, the bevel-gear transmissions 6 and 9 are configured to this end such that there is a taper angle which is different from 90°.

In the embodiments described above and in the first variant, the preferred taper angle is 90°. The shifting of the axes of rotation 19 and 20 in the axial direction from each other results in two points of intersection 33 and 34, which are spaced apart from each other.

The final drive 1 described allows an extremely compact configuration. This is particularly true if another transmission unit, particularly a differential gear unit, preferably an axial differential gear unit, is arranged on the side of the input shafts 2 and 4 facing away from the final drive 1. The final drive 1 is thus used only to provide the permanent operative connection between the first input shaft 2 and the first output shaft 7 on the one hand and between the second input shaft 4 and the second output shaft 10 on the other.

1-10. (canceled)

11. A final drive for a motor vehicle, comprising:
a first input shaft, a second input shaft, a first output shaft, and a second output shaft, wherein the first input shaft is permanently coupled to the first output shaft by a first bevel-gear transmission and the second input shaft is permanently coupled to the second output shaft by means of a second bevel-gear transmission, wherein the first input shaft and the second input shaft are arranged coaxial to each other and the first output shaft and the second output shaft extend from the respective bevel-gear transmissions in opposite directions, wherein an axis plane contains the axes of rotation of the input shafts and a plane perpendicular to the axis plane includes an angle of at least 75° and at most 90° with each of the axes of rotation of the output shafts, and the first bevel-gear transmission and the second bevel-gear transmission are arranged in a drive housing, which has a first housing shell and a second housing shell, which are formed separate from each other and contact each other in a contact plane, which lies in the axis plane or parallel thereto.

12. The final drive according to claim 11, wherein the axes of rotation of the two input shafts and the axes of rotation of the two output shafts lie in the axis plane.

13. The final drive according to claim 11, wherein the first housing shell and the second housing shell are screwed to each other by means of a screw, wherein a central longitudinal axis of the screw is at an angle to the contact plane, particularly, is perpendicular to it.

14. The final drive according to claim 11, wherein the first housing shell comprises a planar first contact surface located in the contact plane and the second housing shell comprises a planar second contact surface located in the contact plane, wherein the first contact surface and the second contact surface rest flatly against each other.

15. The final drive according to claim 11, wherein the screw passes through the first contact surface and/or the second contact surface.

16. The final drive according to claim 11, wherein the first contact surface extends in the direction of the axes of rotation of the input shafts from one end of the first housing shell to its other end, and/or the second contact surface extends in the direction of the axes of rotation of the input shafts from one end of the second housing shell to its other end.

17. The final drive according to claim 11, wherein the first contact surface and/or the second contact surface can each be located partially on a first side and partially on a side opposite said first side in a median plane which contains one of the axes of rotation of the input shafts and is arranged perpendicular to the contact plane.

18. The final drive according to claim 11, wherein the first input shaft and the second input shaft as well as the first output shaft and the second output shaft are each mounted on and/or in the drive housing.

19. The final drive according to claim 11, wherein the first input shaft and the second input shaft are mounted on opposite sides of the bevel-gear transmissions on and/or in the drive housing.

20. The final drive according to claim 11, wherein the first output shaft passes through a first outlet opening of the drive housing and the second output shaft passes through a second outlet opening of the drive housing.
